(19) United States
(12) Patent Application Publication
(10) Pub. No.: US 2014/0200739 A1
(43) Pub. Date: Jul. 17, 2014

(54) ENHANCING VEHICLE CONNECTIVITY

(71) Applicant: David Michael Kirsch, Torrance, CA (US)

(72) Inventor: David Michael Kirsch, Torrance, CA (US)

(73) Assignee: HONDA MOTOR CO., LTD., Tokyo (JP)

(21) Appl. No.: 14/155,791

(22) Filed: Jan. 15, 2014

Related U.S. Application Data
(60) Provisional application No. 61/752,720, filed on Jan. 15, 2013.

(51) Int. Cl. B60R 99/00

(52) U.S. Cl. CPC B60R 99/00
USPC 701/1

(57) ABSTRACT

One or more embodiments of techniques or systems for enhancing vehicle connectivity are provided herein. In one or more embodiments, rule based actions may be implemented in connection with a vehicle. A system may include input devices or input components associated with a vehicle that may receive vehicle data. Output devices or output components associated with the vehicle may generate actions for the vehicle. A control component may monitor data in connection with a rule or a conditional rule. This data may include input data, remote data, etc. The rule may include conditions and corresponding actions. When the input component receives data which satisfies one or more conditions, an action may be generated. In one or more embodiments, the action may be an action remote to the vehicle or an action local to the vehicle.

### CROSS-REFERENCE TO RELATED APPLICATIONS

This application claims the benefit of U.S. Provisional Patent Application, Ser. No. 61/752,720 (Attorney Docket No. 107745.37PRO) entitled “CONNECTION WIZARD”, filed on Jan. 15, 2013. The entirety of the above-noted application is incorporated by reference herein.

### BACKGROUND

As society becomes increasingly interconnected, such as with mobile telephones, mobile devices, or social media platforms, people are often more available, thereby receiving and generating more content than in the past. When operating a vehicle, however, the desire to remain connected may create many unforeseen consequences, such as avoidable accidents, as a result of drivers who are texting or talking on a phone when their attention should be focused on driving. Conventional systems and methods often lack the ability to safely allow drivers to both receive and notify others of important information while enabling the driver to maintain their attention on the road way or focused on the task of driving or operating their vehicle.

### BRIEF DESCRIPTION

This brief description is provided to introduce a selection of concepts in a simplified form that are described below in the detailed description. This brief description is not intended to be an extensive overview of the claimed subject matter, identify key factors or essential features of the claimed subject matter, nor is it intended to be used to limit the scope of the claimed subject matter.

One or more embodiments of techniques or systems for enhancing vehicle connectivity are provided herein. Rule based actions may be implemented in connection with a vehicle. For example, a system may monitor data associated with a vehicle and trigger an action to be initiated in a remote system or a remote service when a condition associated with the data of the vehicle is met or satisfied. Similarly, as another example, a system may monitor data remote from the vehicle and trigger an action to be initiated (e.g., where the action may be local to the vehicle) when a condition associated with the data remote from the vehicle is met or satisfied.

A system for enhancing vehicle connectivity or a system may include one or more input devices or input components, one or more output devices or output components, a control component, and a communication component. The input components may be associated with a vehicle (e.g., configured to receive vehicle data) or the input components may be associated with systems, services, or devices which are remote to the vehicle. The control component may monitor data in connection with a rule or conditional rule. The data being monitored may include input data which is local to the vehicle or input data which is remote to the vehicle, etc. Further, the rule or conditional rule associated with the control component may include one or more conditions and one or more corresponding actions (e.g., actions to be taken or initiated).

When an input component receives data or input data and determines that the received data satisfies one or more of the conditions, one or more actions may be generated. For example, one or more output devices or output components associated with the vehicle may generate actions for the vehicle. As another example, one or more of the output components may be associated with a system remote from the vehicle and generate actions for the system which is remote from the vehicle as a result of data received which is associated with the vehicle. As seen from these examples, the action may be an action remote to the vehicle or an action which is local to the vehicle.

In an exemplary embodiment, a system remote from the vehicle may be a mobile device. The mobile device may determine a location of a vehicle when the vehicle is parked. To this end, the mobile device may monitor weather data associated with the location of the parked vehicle. As an example, if it is raining at the location of the parked vehicle, the vehicle may automatically unlock (e.g., one or more doors, the trunk, etc.) when a user approaches the vehicle based on a rule or condition, such as if rain is detected at the location of the parked vehicle and the location of the mobile device is detected and approaching the location of the parked vehicle, unlock the vehicle at a threshold distance.

In another exemplary embodiment, the system remote from the vehicle or remote system may be a lighting system of a dwelling. Here, when a location of the vehicle is within a threshold distance of the dwelling and the vehicle is approaching the dwelling, the lighting system may be activated. For example, if an individual leaves home for work in the morning and lights of the lighting system are off, one or more of the lights may be turned on or activated as the individual pulls within range of the house when the individual returns. In this way, systems and techniques for enhancing vehicle connectivity are provided.

The following description and annexed drawings set forth certain illustrative aspects and implementations. These are indicative of but a few of the various ways in which one or more aspects are employed. Other aspects, advantages, or novel features of the disclosure will become apparent from the following detailed description when considered in conjunction with the annexed drawings.

### BRIEF DESCRIPTION OF THE DRAWINGS

Aspects of the disclosure are understood from the following detailed description when read with the accompanying drawings. Elements, structures, etc. of the drawings may not necessarily be drawn to scale. Accordingly, the dimensions of the same may be arbitrarily increased or reduced for clarity of discussion, for example.

As used herein, “remote” generally refers to or is intended to mean remote to a vehicle, separate from the vehicle, off-board the vehicle, etc. Similarly, “local” generally refers to or is intended to mean local to a vehicle (e.g., on-board the vehicle).

FIG. 1 is an illustration of an example system for enhancing vehicle connectivity according to one or more embodiments.

FIG. 2 is an illustration of an example flow diagram of a method for enhancing vehicle connectivity, according to one or more embodiments.

FIG. 3 is an illustration of an example flow diagram of a method for enhancing vehicle connectivity, according to one or more embodiments.

FIG. 4 is an illustration of an example interface provided by a system for enhancing vehicle connectivity, according to one or more embodiments.

FIG. 5 is an illustration of an example implementation of a system for enhancing vehicle connectivity, according to one or more embodiments.

FIG. 6 is an illustration of an example computer-readable medium or computer-readable device including processor-executable instructions configured to embody one or more of the provisions set forth herein, according to one or more embodiments.

FIG. 7 is an illustration of an example computing environment where one or more of the provisions set forth herein are implemented, according to one or more embodiments.

### DETAILED DESCRIPTION

Embodiments or examples, illustrated in the drawings are disclosed below using specific language. It will nevertheless be understood that the embodiments or examples are not intended to be limiting. Any alterations and modifications in the disclosed embodiments, and any further applications of the principles disclosed in this document are contemplated as would normally occur to one of ordinary skill in the pertinent art.

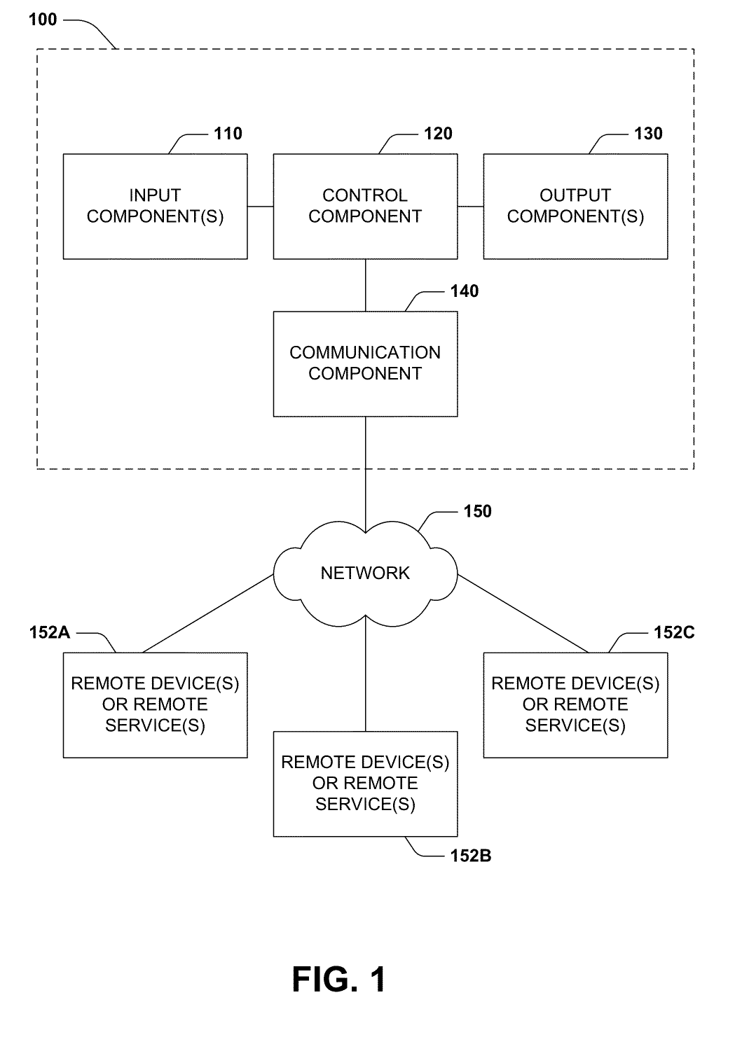

For one or more of the figures herein, one or more boundaries, such as boundary 100 of FIG. 1, for example, may be drawn with different heights, widths, perimeters, aspect ratios, shapes, etc. relative to one another merely for illustrative purposes, and are not necessarily drawn to scale. For example, because dashed or dotted lines may be used to represent different boundaries, if the dashed and dotted lines were drawn on top of one another they would not be distinguishable in the figures, and thus may be drawn with different dimensions or slightly apart from one another, in one or more of the figures, so that they are distinguishable from one another. As another example, where a boundary is associated with an irregular shape, the boundary, such as a box drawn with a dashed line, dotted lined, etc., does not necessarily encompass an entire component in one or more instances. Conversely, a drawn box does not necessarily encompass merely an associated component, in one or more instances, but may encompass a portion of one or more other components as well.

In one or more embodiments, one or more conditional rules may be implemented in connection with a vehicle and one or more remote devices or one or more remote services. A rule may be associated with one or more conditions. For example, when one or more of the conditions of the rule are met or satisfied, then one or more actions or one or more outputs associated with the rule may be initiated, provided, taken, or generated. These rules may be pre-generated, customizable, user-generated, etc. Additionally, a rule may allow a user (e.g., driver, owner, operator, etc.) to interconnect functionality of the vehicle with one or more other devices or services (e.g., which may be remote to the vehicle) in a variety of ways. For example, a rule may be implemented to monitor a vehicle and determine when or if the vehicle is stolen. To this end, upon determination that the vehicle is stolen, one or more individuals or entities may be notified, such as the user or a third party (e.g., the police, etc.). Notifications may be provided in one or more forms (e.g., a phone call, an email, a text message, etc.).

In another example, when the location of the vehicle departs or arrives at a residence or other location (e.g., as determined by a global positioning system (GPS) or other location determination techniques, lights or other devices (e.g., remote to the vehicle or external to the vehicle) at the residence may be turned on or off, or one or more entities may be notified. In a further example, when the vehicle is low on fuel (e.g., is associated with a fuel level below a threshold fuel level), is due for maintenance (e.g., approaching five thousand miles on a current oil change) or a need for maintenance is otherwise detected, then a reminder or notification may be sent (e.g., email, phone, text, etc.). In one or more embodiments, rules may be triggered based on a geo-fence or virtual perimeter associated with a location, or a predetermined distance from the location, etc.

Users may create, customize, or select rules (e.g., conditional rules) for implementation via a wizard-type interface that may provide an interface to one or more underlying features disclosed herein. For example, the interface may enable pre-made rules to be selected as-is, enable customization of the pre-made rules, or enable users to design rules (e.g., from scratch) by selecting one or more actions (e.g., desired actions) to be automatically performed and one or more corresponding conditions. Rules may thus be fully customized or built utilizing pre-made ‘recipes’ which link or associate one or more conditions with one or more actions. When a condition is met or satisfied, one or more of the corresponding actions may performed as a result of the condition being satisfied.

For example, vehicle-specific conditions or triggers may include rules or conditions based on one or more vehicle characteristics, such as the detection of a stolen vehicle condition, a low fuel level, required maintenance, activation of a security alarm, reaching a destination location, or other location-based triggers, such as entering or leaving a location as defined by a geo-fence, presence, absence, or identity of a linked device (e.g., via Bluetooth™), etc., as well as any other features or aspects of a vehicle that may be monitored, such as tire pressure, outside temperature or thermostat settings, speed, weather conditions, car stereo settings, etc.

Further, rules may be defined based on one or more conditions associated with these or any other characteristics local to the vehicle (e.g., the condition may be that a characteristic has a value or state, has any of a plurality of values or states, is in a range of values or states, is greater than or less than a value, etc.), and these rules may cause actions to occur remotely or locally based on the condition(s) being met. Remote actions may be through any of a variety of remote devices or remote services, such as generating a phone call, text message, email, creating a calendar entry, generating or posting social media content (e.g., via Twitter, Facebook, etc.), generating a query to one or more remote devices or services (e.g., searching for gas prices along upcoming portions of a route or in a vicinity when a fuel level is low, searching for nearby restaurant options, searching for weather alerts along a route, etc.), activating one or more remote devices (e.g., lights or appliances in a residence upon approach), etc.

Additionally, when one or more conditions of a rule are met (e.g., for rules with multiple conditions, an option may be provided to select what combination of conditions triggers the rule, for example, whether at least one condition must be met to trigger the rule or whether all conditions must be met or satisfied, etc.), actions or output may be triggered or generated at a vehicle, such as sending a message to a car, sending a destination to a car (e.g., to a navigation system, etc.), querying a car for its location, remotely operating at least one system of a car (e.g., remote door lock/unlock, remote start, etc.), sending contact information to a car, sending user settings to a car (e.g., user settings for one or more vehicle systems such as seat or mirror positioning, radio stations, thermostat preferences, etc. may be maintained remotely and provided to a car upon one or more conditions), etc.

Remote conditions that may trigger actions at a vehicle may include any of a variety of conditions associated with remote devices or services discussed herein, such as receiving a call, text or email (or receiving one from a specified contact or contact in a specified group), the existence of a weather condition, approaching a location or type of location, an upcoming or current calendar entry or proposed calendar entry, activation or deactivation of a device (e.g., lights being turned on in a residence when the user is not present, etc.), social media activity (e.g., via Facebook, Twitter), etc.

FIG. 1 is an illustration of an example system 100 for enhancing vehicle connectivity according to one or more embodiments. The system 100 for enhancing vehicle connectivity may include one or more input components 110, a control component 120, one or more output components 130, and a communication component 140. The control component 120 may include a storage component (not shown) for storing one or more rules. Effectively, a rule (e.g., of one or more of the rules) may include one or more conditions (e.g., one or more triggers) and one or more actions. When one or more of the conditions of a rule is met or satisfied (e.g., a triggering event occurs), one or more actions associated with the rule may be executed, performed, or initiated. One or more of the input components 110 may facilitate monitoring data for data which satisfies one or more of these conditions while one or more of the output components 130 may facilitate execution or initiation of one or more of the actions associated with a rule.

The control component 120 may implement one or more of the rules in connection with data, which may be received remotely or from one or more input components 110. As discussed herein, the control component 120 may execute actions on-board a vehicle based on inputs or occurrences off-board of the vehicle. Similarly, in other embodiments, the control component 120 may execute actions on systems off-board the vehicle based on inputs received on-board the vehicle. For example, one or more of the input components 110 may include one or more vehicle sensors (e.g., on-board of the vehicle), information, or data internally from the vehicle, such as from a controller area network (CAN). As another example, input components 110 may receive data from one or more input devices associated with the vehicle (e.g., voice, buttons, switches, touchscreen, etc.). Input components 110 may also receive data from a mobile device associated with the vehicle (e.g., a mobile device located within the vehicle, docked to the vehicle, communicatively coupled with the vehicle via a wired connection, a wireless connection, etc.). In yet other embodiments, the input components 110 may receive or monitor data from sources which are remote or external to the vehicle, such as from an alarm associated with a dwelling or home, for example. The input components 110 may also monitor or receive information or data associated with a user, driver, occupant, operator, etc. of the vehicle.

Explained another way, one or more of the input components 110 may monitor local inputs (e.g., inputs on a vehicle) for a vehicle or at a vehicle associated with one or more rules. For example, when a rule is turn the lights on to a house when a vehicle is approaching the house and when the vehicle is within 800 meters of the house (e.g., geo-fence around the house), the input components 110 may monitor whether the vehicle is approaching the house and whether the location of the vehicle is within the 800 meter proximity of the house. In other embodiments, the input components 110 may monitor inputs which may be remote from the vehicle in connection with a rule.

Depending on the rule, the control component 120 may activate one or more output components 130 to cause, initiate, activate, execute, transmit, etc. an appropriate response to one or more conditions of the rule being met, satisfied, or otherwise triggered. Again, the control component 120 may cause the output components 130 to execute an action at or local to the vehicle or at a system external or remote to the vehicle.

In one or more embodiments, the control component 120 may cause communication component 140 to transmit data via network 150 to one or more remote devices or remote services 152A, 1528, 152C, etc. In other words, the control component 120 may indicate (e.g., by providing instructions or data indicating that one or more conditions of a rule have been met, satisfied, triggered, etc.) that a rule is triggered and notify one or more remote entities to take appropriate or corresponding action. The network 150 may include the Internet, a local area network, a wide area network, etc. As a result of receiving these communications, triggers, actions, instructions, etc. across the network 150, one or more of the remote devices or remote services 152A, 152B, 152C, etc. may perform one or more actions or generate one or more outputs in accordance with actions associated with the corresponding rule.

According to one or more aspects, the control component 120 may provide data between one or more of the input components 110, one or more of the output components 130, and the communication component 140. However, implementations of one or more rules may occur in a remote manner. For example, one or more servers (not shown) connected to the network 150 may be utilized to process one or more of the rules. System 100 may implement one or more rules in a variety of ways, based on the rule. One or more rules may be associated with one or more conditions (e.g., when to trigger), and actions (e.g., responses). When one or more conditions are met or satisfied, one or more actions may be performed or initiated. Further, rules, actions, conditions, triggers, etc. may be local to the system 100, local to a vehicle, remote to the system 100, or remote to a vehicle.

The control component 120 may determine when data received from one or more of the input components 110 is in accordance with, satisfies, or meets one or more conditions associated with one or more rules. In one or more embodiments, one or more of the rules may be stored on a storage component or stored on the control component 120. In other embodiments, one or more of the rules may be accessed via the communication component 140 via a connection to the network 150 (e.g., and stored on one or more servers). To this end, the control component 120 may determine when or whether an input, a local input, or data received by the input components 110 satisfies a condition associated with a corresponding rule. In other words, the control component 120 may test data from the input components 110 to determine whether or not the data should trigger a rule or not.

When the control component 120 determined that a rule has been triggered, one or more corresponding actions may be determined pursuant to the triggering of the rule. For example, when a rule is implemented such that the input components 110 monitor data associated with the vehicle, closely tied to the vehicle (e.g., associated with a mobile device within the vehicle, etc.), or on-board the vehicle, the control component 120 may determine one or more actions which are remote from the vehicle corresponding to a rule. As another example, when a rule is implemented such that the input components 110 monitor data remote from the vehicle, the control component 120 may determine one or more actions which are local to the vehicle corresponding with a rule.

The control component 120 enables implementation of an if-then type clause according to conditions on-board of a vehicle or remote or external to the vehicle. Further, the control component 120 provides actions which may be taken on-board or off-board the vehicle. In one or more embodiments, the conditions and actions are opposite one another such that connectivity between the vehicle and the external environment or remote environment are enhanced. For example, if one or more of the conditions being monitored are on-board the vehicle, one or more of the actions being taken will be off-board the vehicle and vice versa. In this way, the control component 120 may provide effects, actions, trigger actions, etc. in response to or as a result of one or more conditions being satisfied, thereby enabling a user to implement custom if-then logic according to their needs.

The output component 130 may instruct a device to perform one or more actions in accordance with a rule implemented by the control component 120. The output component 130 may instruct a device local to the vehicle (e.g., local device) to perform an action on-board of the vehicle. The output component 130 may also instruct a device remote to the vehicle (e.g., remote device) to perform an action off-board of the vehicle. In this way, the system 100 enables the remote activation of one or more vehicle components based on one or more non-vehicle conditions or the remote activation of non-vehicle components based on one or more conditions associated with the vehicle. Because non-vehicle conditions may be linked to vehicle actions or vehicle conditions may be linked (e.g., via cloud integration, telematics, network 150, etc.) to non-vehicle actions, the system 100 may connect a digital footprint of the user with a vehicle of the user, thereby providing the user with a personalized experience or an always connected feeling while operating the vehicle.

In one or more embodiments, a user may have an account associated with the system 100 or rule based system local to a vehicle or the account may exist separate from the vehicle. Regardless, the user may login to their account, and communicatively couple a mobile device, such as a smartphone, with a vehicle. A user may automatically be logged into their account upon pairing their mobile device with the vehicle. In one or more scenarios, the logging in itself may be a condition which may trigger one or more actions, such as implementation of one or more user settings for the vehicle (e.g., seat positioning, mirror positioning, radio presets, connection with a music service, notifying an entity of a location of that vehicle, etc.).

As discussed herein, a rule may include one or more conditions and one or more corresponding actions. In one or more embodiments, a condition of one or more of the conditions may be associated with the vehicle or be vehicle based. For example, one or more of the conditions may be based on a characteristic associated with the vehicle, such as a location of the vehicle, a proximity of the vehicle to a location, a location of a mobile device associated with the vehicle, a fuel level of the vehicle, or other vehicle characteristic. Additional examples of this may include maintenance characteristics, such as mileage (e.g., mileage associated with an oil change), tire pressure, thermostat settings, velocity of the vehicle, current velocity, stereo settings, presets, whether the vehicle is stolen (e.g., as indicated by an anti-theft device), etc. An action of one or more of the actions may be associated with a system or device remote to the vehicle or be remotely based. For example, an action may include activation of remote electronics, devices, appliances, launching of applications, generating a query on a device, such as a mobile device, generating a notification (e.g., email, text, phone call, calendar appointment, arrival time, departure time), generating or posting social media content, etc.

Conversely, in other embodiments, a condition may be associated with a system remote to the vehicle or be remotely based. For example, a condition may include receiving an email from a group or designated individual (e.g., a VIP), having a calendar appointment pending, activation of security, tracking environmental characteristics (e.g., outside temperature, weather conditions, etc.). An action may be associated with the vehicle or be vehicle based. For example, an action which is associated with the vehicle or is vehicle based may include locking or unlocking doors of the vehicle, popping the trunk, automatically starting the vehicle, providing in-vehicle notifications (e.g., a notification may override the audio system of the vehicle and read text to speech of a message, etc.), activating navigation or re-routing existing navigation, vehicle finder, contacts to the vehicle, porting user settings over to the vehicle, etc.

In one or more embodiments, the control component 120 may be configured to implement a variety of rules. For example, a rule may be conditioned on arrival at one's home or dwelling (e.g., based on a location of the vehicle, which may be determined via a geo-fence) which triggers activation of house lights or other electronic devices in the home, notify one or more entities, etc. Here, the condition may be that the location of the vehicle is within a threshold distance of the home or dwelling and that the vehicle is approaching the home or the vehicle is within a time window (e.g., such as arriving between 5:00 PM and 7:00 PM). Additionally, other conditions may be added, such as a brightness threshold or a time at which the sun sets, etc. The actions, as mentioned may include activation of electronics or other devices within the home. In one or more embodiments, such activation (or deactivation) may be achieved via the communication component 140 and/or one or more applications at the remote end or running on a remote device.

As another example, a rule may be conditioned on detection of maintenance associated with the vehicle. As a response, the output component 130 may create a calendar entry or calendar appointment to schedule a service for the vehicle. For example, when a vehicle has been utilizing the same oil and rolls to the five thousandth mile on the same oil change, the control component 120 may have the communication component 140 communicate across the network 150 to email the user or an associated account that an oil change is due. In other embodiments, a task may be added to a “To-Do” list for the user. When a check engine light comes on, the vehicle may text, call, or notify the user. The control component 120 may schedule a service with a mechanic automatically as well.

In one or more embodiments, a rule may be conditioned to record information or data in a passive manner. For example, a rule may indicate or record arrival or departure times associated with a vehicle and one or more origin locations or destinations. The control component 120 may store the corresponding times locally on-board the vehicle or on a server across the network 150. In this way, the system 100 may be utilized for timekeeping (e.g., hourly wage) purposes, for example.

A rule may be conditions based on a characteristic of the vehicle or vehicle characteristic, such as a fuel level associated with the vehicle. Associated or corresponding actions to an indication or a low fuel level (e.g., below a fuel level threshold) may include sending a notification to a user, creating a calendar entry, generating a query for fuel prices, initiating navigation to a gas or fuel station, etc. As an example, if a user or driver is utilizing navigation, a low fuel level rule may redirect or re-route that driver to a gas station when his or her fuel is low and continue routing them to their destination when they fuel up or fill up their fuel tank. Here, the condition would be fuel below a certain threshold. The corresponding action may include navigating or re-routing to a fuel station nearby or along the route to the destination location. In one or more embodiments, the control component 120 may query for cheap fuel pricing and direct a user or driver to a cheaper gas station, rather than a more expensive one, for example.

A rule may be conditioned on arriving at a destination associated with a calendar entry or appointment. An action or response to arrival at the destination may be to lookup contact information for one or more other individuals, parties, or entities and generate a notification for one or more of those entities. For example, if a first individual has a dinner reservation with a second individual at location X, when the first individual arrives at location X at a time specified in a calendar appointment, the control component 120 may lookup contact information for the second individual and issue them a notification (e.g., a text message, email, etc.) that the first individual has arrived at location X for their dinner reservation.

Other rules may be conditioned on a security alarm (e.g., the vehicle is stolen, security breach, window broken, etc.) being generated by the vehicle that notifies a user (e.g., via text, email, etc.).

In one or more embodiments, conditions of the rule may be remotely based. For example, when a user updates settings in a mobile device or other device (e.g., desktop computer), one or more of those settings may be synchronized or ported over to the vehicle (e.g., user settings for one or more vehicle systems such as seat or mirror positioning, radio stations, thermostat preferences, etc. may be maintained remotely and provided to a car upon one or more conditions, etc.).

A rule may be conditioned on receiving an email (e.g., from a pre-defined list of email addresses, individuals, entities, from one or more specific users, from one or more groups of users, etc.) while driving that provides a notification of the message or provides a text-to-speech version of the message. For example, if a user receives an email from his or her boss (e.g., a pre-defined individual or email address), the control component 120 may provide text to speech (TTS) for the email, while other emails may not necessarily be read aloud to the user. In this way, the system 100 of FIG. 1 enables users to screen correspondence.

A rule may be conditioned on a current or upcoming calendar appointment associated with a destination, which triggers a vehicle navigation system to determine a route to that destination. For example, if a user has a calendar appointment for a meeting with a new client, the control component 120 may trigger navigation to a designated meeting location associated with the appointment prior to the appointment.

Rules may be conditioned on weather at a location associated with the vehicle or weather at another location. For example, the input component 110 may monitor weather conditions at a residence and provide notifications to a user or an operator of a vehicle when a weather advisory exists for the location associated with the residence. Further, a rule may be conditioned on both a weather state and a time of day (e.g., cold weather shortly before a user leaves for work on weekdays) that remotely activates the vehicle and a climate control system at the specified time on the specified days to heat the vehicle. For example, a rule may state that if the temperature is below a certain threshold, if it is 4:45 PM on a work night, and the vehicle is at a location associated with work, and these conditions are satisfied, that the vehicle start at 4:45 PM (e.g., to warm the vehicle up in anticipation of a worker heading home). The rule may shut the vehicle off after a predetermined amount of time and no activity, for example.

Another rule may be conditioned on precipitation and detecting the location of an individual approaching a vehicle (e.g., via GPS of a mobile device, for example) and having the action include unlocking one or more doors to the vehicle when the location of the individual is determined to be within a threshold distance of the vehicle. In this way, the vehicle may be automatically unlocked when it is raining outside, for example. In another embodiment, when a vehicle is located at a grocery store or other store, and an individual (e.g., owner or driver of the vehicle) is approaching the vehicle, the trunk may automatically be popped. Here, the input component 110 may monitor the location of the vehicle (e.g., to determine that the vehicle is at a store) and the location of the individual (e.g., to determine when to pop the trunk). The output component 130 may pop the trunk when the control component 120 determines that the individual or owner is within a threshold distance of his or her vehicle.

For purposes of simplicity of explanation, one or more methodologies or techniques described herein (e.g., in the form of a flow diagram), are shown or described as a series of acts, it is to be understood and appreciated that the subject disclosure is not limited by the order of acts, as some acts may, in accordance with the disclosure, occur in a different order and/or concurrently with other acts from that shown and described herein. Those skilled in the art will understand and appreciate that a methodology could alternatively be represented as a series of interrelated states or events, such as in a state diagram. Moreover, not all illustrated acts may be required to implement a methodology in accordance with the disclosure.

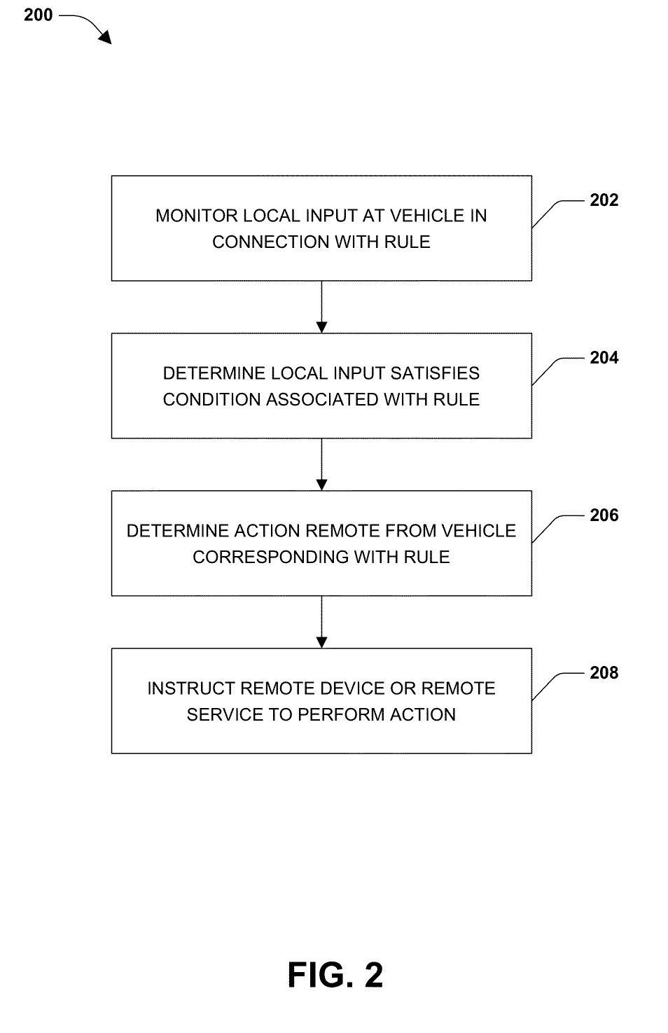

FIG. 2 is an illustration of an example flow diagram of a method 200 for enhancing vehicle connectivity, according to one or more embodiments. The method 200 may include monitoring a local input at a vehicle in connection with a rule at 202, determining whether the local input satisfies one or more conditions associated with the rule at 204, determining one or more actions remote from the vehicle, wherein one or more of the actions correspond with the rule at 206, and instructing a remote device or remote service to perform one or more of the actions at 208. One or more of the conditions described in the method 200 may include most any of a variety of conditions described herein.

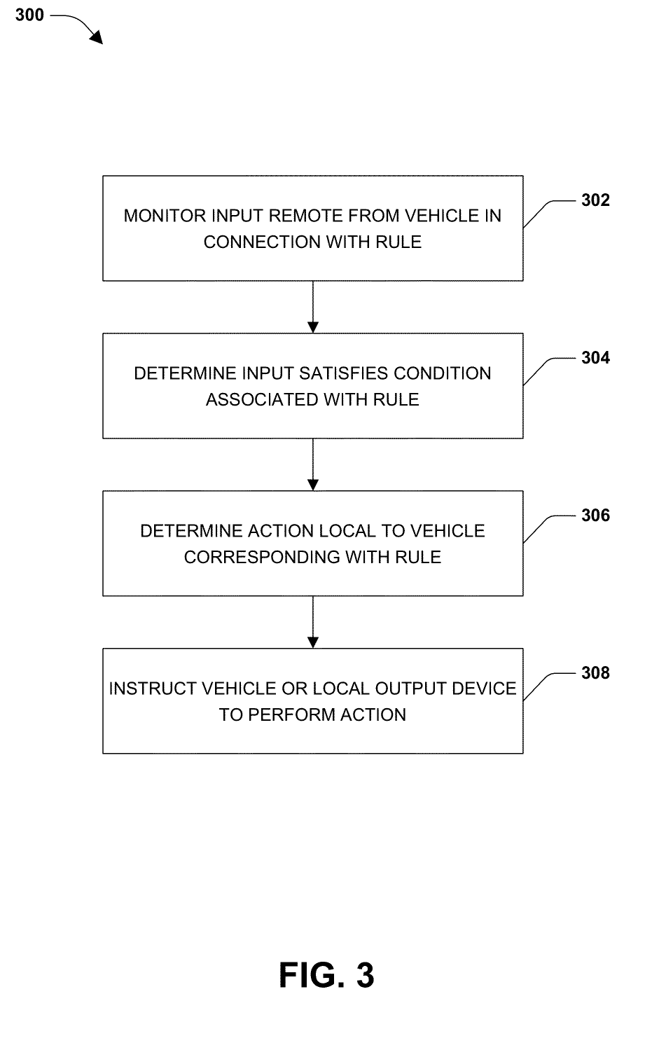

FIG. 3 is an illustration of an example flow diagram of a method 300 for enhancing vehicle connectivity, according to one or more embodiments. At 302, an input may be monitored which is remote from the vehicle, the input monitored may be in connection with a rule. At 304, it may be determined whether or not the input satisfies one or more conditions associated with the rule. At 306, one or more actions may be determined, where an action may be local to the vehicle. At 308, the vehicle may be instructed to perform one or more of the actions. In one or more embodiments, a local output device associated with the vehicle may perform one or more of the actions (e.g., a mobile device docked to the vehicle, for example).

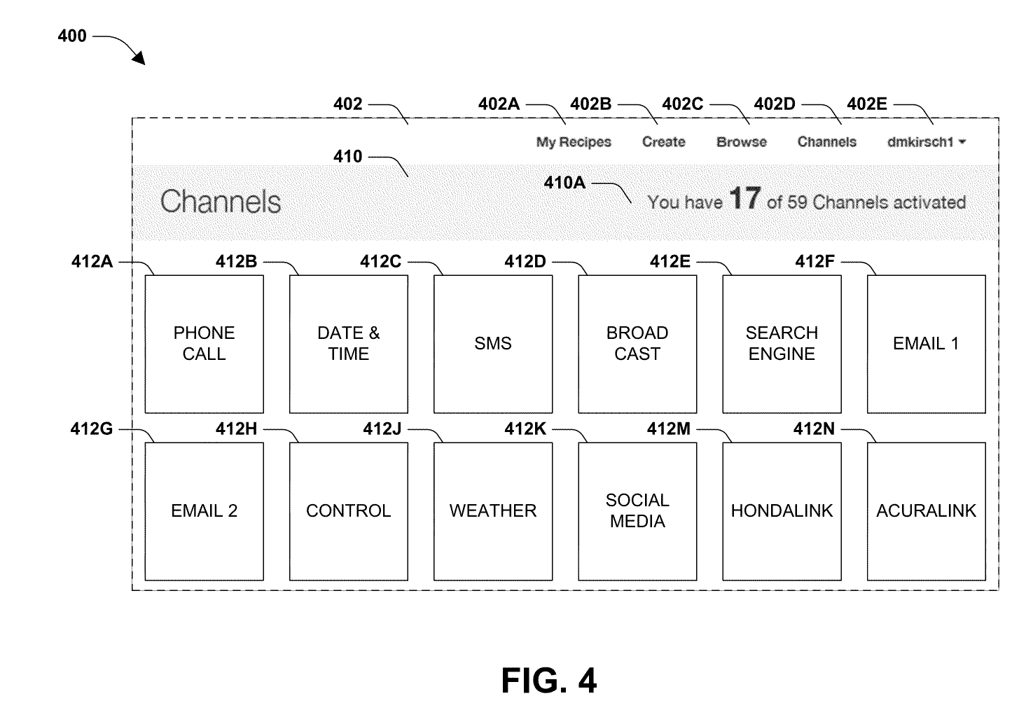

FIG. 4 is an illustration of an example interface 400 provided by a system for enhancing vehicle connectivity, according to one or more embodiments. The interface 400 may include menu bar 402 and channel bar 410 which may indicate a number of channels active 410A. The menu bar 402 may include one or more tabs 402A, 402B, 402C, 402D, 402E, etc. 412A-412N may be icons, shortcuts, notifications, etc. provided by the system 100 of FIG. 1. In one or more embodiments, the system 100 of FIG. 1 may include a display component (not shown) for presenting the interface 400 of FIG. 4.

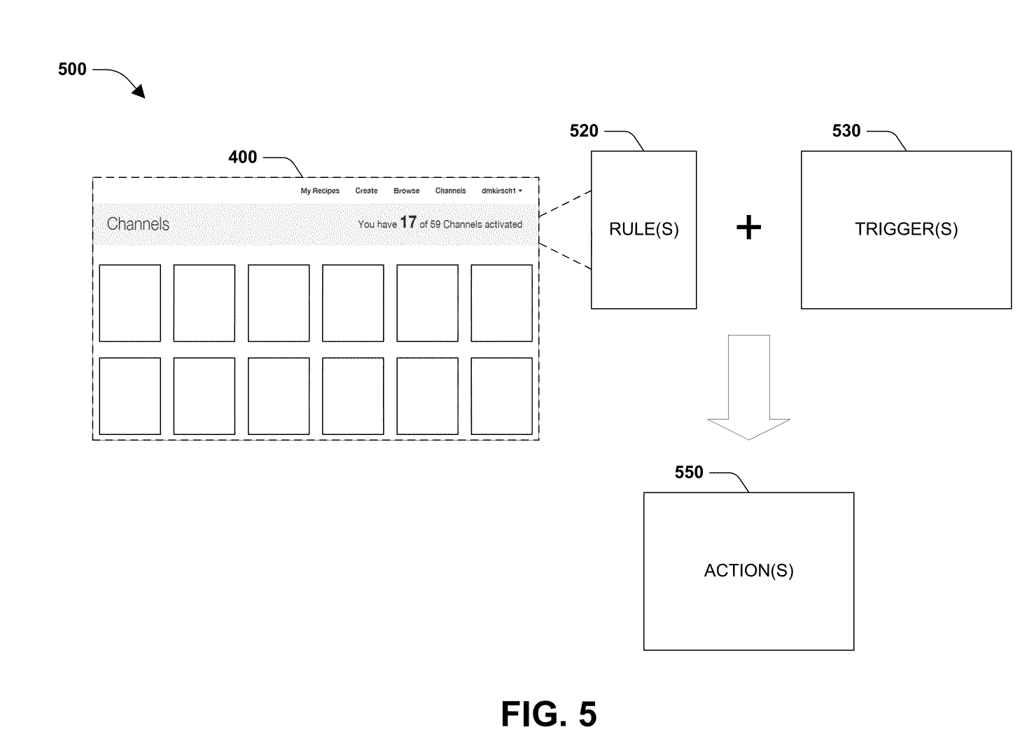

FIG. 5 is an illustration of an example implementation 500 of a system for enhancing vehicle connectivity, according to one or more embodiments. When one or more rules 520 are triggered by one or more trigger events 530, one or more actions 550 may be taken as a response. The interface 400 of FIG. 4 may be configured to implement one or more of the rules 520 to detect one or more corresponding conditions or to perform one or more of the actions 550, depending on the setup of the rule (e.g., vehicle related condition to non-vehicle action, or non-vehicle related condition to vehicle related action, etc.).

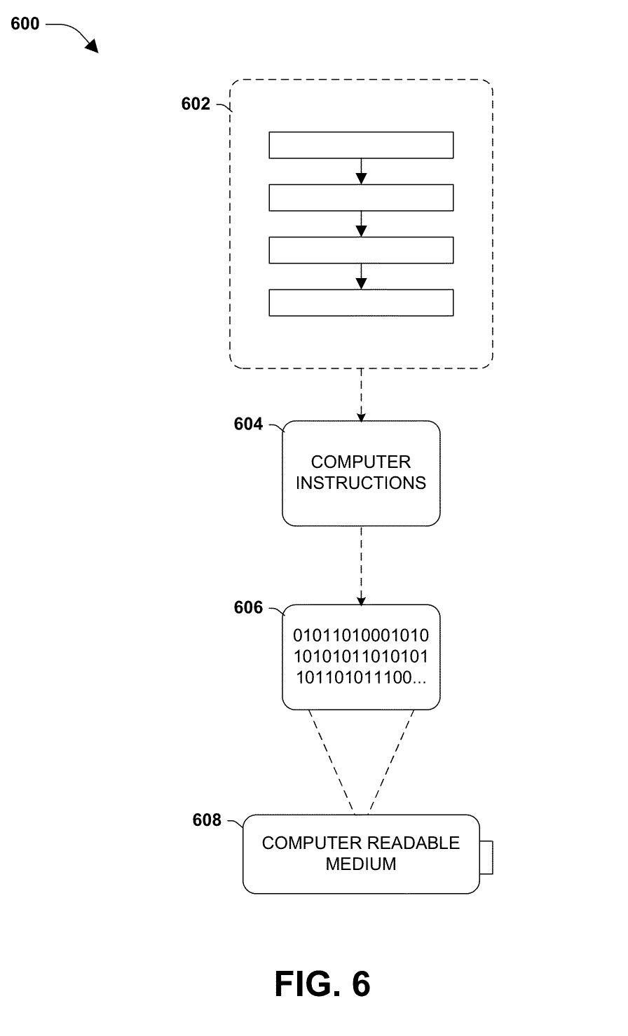

Still another embodiment involves a computer-readable medium including processor-executable instructions configured to implement one or more embodiments of the techniques presented herein. An embodiment of a computer-readable medium or a computer-readable device devised in these ways is illustrated in FIG. 6, wherein an implementation 600 includes a computer-readable medium 608, such as a CD-R, DVD-R, flash drive, a platter of a hard disk drive, etc., on which is encoded computer-readable data 606. This computer-readable data 606, such as binary data including a plurality of zero's and one's as shown in 606, in turn includes a set of computer instructions 604 configured to operate according to one or more of the principles set forth herein. In one such embodiment 600, the processor-executable computer instructions 604 are configured to perform a method 602, such as the method 200 of FIG. 2 or the method 300 of FIG. 3. In another embodiment, the processor-executable instructions 604 are configured to implement a system, such as the system 100 of FIG. 1. Many such computer-readable media are devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

As used herein, the term to “infer” or “inference” refer generally to the process of reasoning about or inferring states of the system, environment, and/or user from a set of observations as captured via events and/or data. Inference may be employed to identify a specific context or action, or may generate a probability distribution over states, for example. The inference may be probabilistic. For example, the computation of a probability distribution over states of interest based on a consideration of data and events. Inference may also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

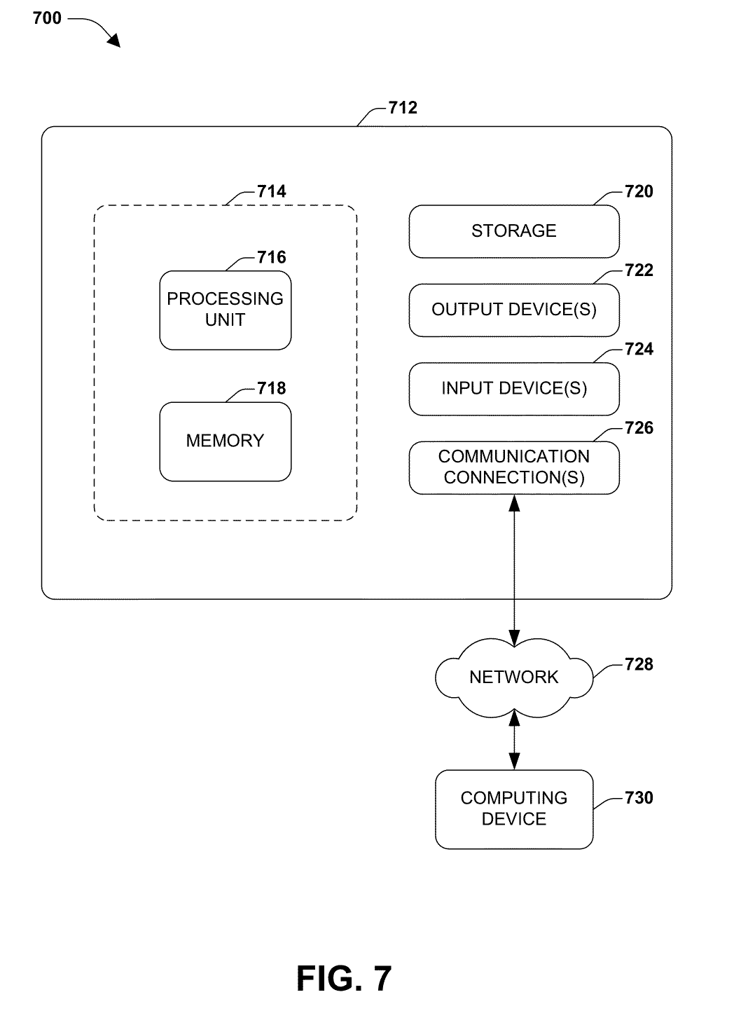

FIG. 7 and the following discussion provide a description of a suitable computing environment to implement embodiments of one or more of the provisions set forth herein. The operating environment of FIG. 7 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 7 illustrates a system 700 including a computing device 712 configured to implement one or more embodiments provided herein. In one configuration, computing device 712 includes at least one processing unit 716 and memory 718. Depending on the exact configuration and type of computing device, memory 718 may be volatile, such as RAM, non-volatile, such as ROM, flash memory, etc., or a combination of the two. This configuration is illustrated in FIG. 7 by dashed line 714.

In other embodiments, device 712 includes additional features or functionality. For example, device 712 may include additional storage such as removable storage or non-removable storage, including, but not limited to, magnetic storage, optical storage, etc. Such additional storage is illustrated in FIG. 7 by storage 720. In one or more embodiments, computer readable instructions to implement one or more embodiments provided herein are in storage 720. Storage 720 may store other computer readable instructions to implement an operating system, an application program, etc. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by device 712. Any such computer storage media is part of device 712.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 712 includes input device(s) 724 such as keyboard, mouse, pen, voice input device, touch input device, infrared cameras, video input devices, or any other input device. Output device(s) 722 such as one or more displays, speakers, printers, or any other output device may be included with device 712. Input device(s) 724 and output device(s) 722 may be connected to device 712 via a wired connection, wireless connection, or any combination thereof. In one or more embodiments, an input device or an output device from another computing device may be used as input device(s) 724 or output device(s) 722 for computing device 712. Device 712 may include communication connection(s) 726 to facilitate communications with one or more other devices.

According to one or more aspects, a system for enhancing vehicle connectivity is provided including one or more input components associated with the vehicle receiving data associated with activity remote to the vehicle, a control component monitoring the data in connection with a rule, wherein the rule may include one or more conditions and one or more actions, wherein the data may include one or more triggering events which satisfy one or more of the conditions of the rule, and one or more output components associated with the vehicle generating one or more actions for the vehicle.

In one or more embodiments, the data may include location information or coordinates. The data may include an indication that maintenance is required. One or more of the actions may include navigating to a destination.

According to one or more aspect, a method for enhancing vehicle connectivity is provided, including monitoring an input local to a vehicle in connection with a rule, determining whether the local input satisfies one or more conditions associated with the rule, determining one or more actions remote from the vehicle, wherein one or more of the actions correspond with the rule, and instructing a remote device or a remote service to perform one or more of the actions.

In one or more embodiments, the input local to the vehicle is determining a location of the vehicle. One or more of the conditions may be associated with a geo-fence of a location. One or more of the actions may include providing a notification as to the location of the vehicle. One or more of the actions may include enabling or disabling one or more remote devices. The input local to the vehicle may be a status indicator associated with maintenance of the vehicle. One or more of the conditions may be associated with the status indicator. One or more of the actions may include providing a notification to a user based on the status indicator.

According to one or more embodiments, a method for enhancing vehicle connectivity, is provided including monitoring an input remote from a vehicle in connection with a rule, determining whether the input remote from the vehicle satisfies one or more conditions associated with the rule, determining one or more actions local to the vehicle, wherein one or more of the actions correspond with the rule, and instructing the vehicle or an associated local output device to perform one or more of the actions.

According to one or more embodiments, the input remote from the vehicle may be a communication from a predetermined entity. One or more of the actions local to the vehicle may provide a text to speech notification of the communication. The input remote from the vehicle may be associated with a security alarm. One or more of the conditions may be associated with a status of the security alarm. One or more of the actions includes providing one or more notifications based on the status of the security alarm. In one or more embodiments, the method includes providing one or more notifications based on one or more of the actions. One or more of the notifications may be an email or text message.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described shall not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

Although the disclosure has been shown and described with respect to one or more implementations, equivalent alterations and modifications will occur based on a reading and understanding of this specification and the annexed drawings. In other words, what has been described herein includes examples of the disclosure. It is, of course, not possible to describe every conceivable combination of components or methodologies for purposes of describing the subject disclosure, but one of ordinary skill in the art may recognize that many further combinations and permutations of the disclosure are possible. Accordingly, the disclosure is intended to embrace all such alterations, modifications, and variations that fall within the spirit and scope of the appended claims. The disclosure includes all such modifications and alterations and is limited only by the scope of the following claims.

What is claimed is:

1. A system for enhancing vehicle connectivity, comprising:
one or more input components associated with the vehicle receiving data associated with activity remote to the vehicle;
a control component monitoring the data in connection with a rule, wherein the rule comprises one or more conditions and one or more actions, wherein the data comprises one or more triggering events which satisfy one or more of the conditions of the rule; and
one or more output components associated with the vehicle generating one or more actions for the vehicle, wherein one or more of the input components, the control component, or one or more of the output components is implemented via a processing unit.

2. The system of claim 1, wherein the data comprises location information or coordinates.

3. The system of claim 1, wherein the data comprises an indication that maintenance is required.

4. The system of claim 1, wherein one or more of the actions comprises navigating to a destination.

5. A method for enhancing vehicle connectivity, comprising:
monitoring an input local to a vehicle in connection with a rule;
determining whether the local input satisfies one or more conditions associated with the rule;
determining one or more actions remote from the vehicle, wherein one or more of the actions correspond with the rule; and
instructing a remote device or a remote service to perform one or more of the actions, wherein the monitoring, the determining, or the instructing is implemented via a processing unit.

6. The method of claim 5, wherein the input local to the vehicle is determining a location of the vehicle.

7. The method of claim 6, wherein one or more of the conditions is associated with a geo-fence of a location.

8. The method of claim 7, wherein one or more of the actions comprises providing a notification as to the location of the vehicle.

9. The method of claim 7, wherein one or more of the actions comprises enabling or disabling one or more remote devices.

10. The method of claim 5, wherein the input local to the vehicle is a status indicator associated with maintenance of the vehicle.

11. The method of claim 10, wherein one or more of the conditions is associated with the status indicator.

12. The method of claim 11, wherein one or more of the actions comprises providing a notification to a user based on the status indicator.

13. A method for enhancing vehicle connectivity, comprising:
monitoring an input remote from a vehicle in connection with a rule;
determining whether the input remote from the vehicle satisfies one or more conditions associated with the rule;
determining one or more actions local to the vehicle, wherein one or more of the actions correspond with the rule; and
instructing the vehicle or an associated local output device to perform one or more of the actions, wherein the monitoring, the determining, or the instructing is implemented via a processing unit.

14. The method of claim 13, wherein the input remote from the vehicle is a communication from a predetermined entity.

15. The method of claim 14, wherein one or more of the actions local to the vehicle is providing a text to speech notification of the communication.

16. The method of claim 13, wherein the input remote from the vehicle is associated with a security alarm.

17. The method of claim 16, wherein one or more of the conditions is associated with a status of the security alarm.

18. The method of claim 17, wherein one or more of the actions is providing one or more notifications based on the status of the security alarm.

19. The method of claim 13, comprising providing one or more notifications based on one or more of the actions.

20. The method of claim 19, wherein one or more of the notifications is an email or a text message.
